(19) United States
(12) Patent Application Publication
(10) Pub. No.: US 2021/0010636 A1
(43) Pub. Date: Jan. 14, 2021

(54) ASSEMBLY FOR MOUNTING ARTICLES ON A VERTICAL SURFACE

(71) Applicants: Wade Schane, Lowell, IN (US); Renee L. Venditti, Cedar Lake, IN (US)

(72) Inventors: Wade Schane, Lowell, IN (US); Renee L. Venditti, Cedar Lake, IN (US)

(21) Appl. No.: 16/509,293

(22) Filed: Jul. 11, 2019

(51) Int. Cl. F16M 13/02; F16M 11/22; F16M 11/04

(52) U.S. Cl. CPC F16M 13/02; F16M 11/04; F16M 11/22

(57) ABSTRACT

Disclosed herein is a gravity bracket assembly for suspending articles therefrom and which bracket assembly is adapted for mounting to and through supporting structures of differing thicknesses. The gravity bracket assembly disclosed herein includes a mounting bracket, a receiving bracket, and a fastener for securing the brackets together. When assembled, the gravity bracket assembly allows for the mounting of articles to a vertical wall at a particular displacement from the wall.

### FIELD OF THE INVENTION

The invention disclosed herein relates to brackets for attaching articles to vertical wall, and more specifically to brackets for attaching articles to vertical walls so that the article is spaced apart for the wall at a distance, allowing a veneer to be placed between the article and the vertical wall.

### BACKGROUND OF THE INVENTION

With the advent of the flat screen video display, it has become common for consumers to mount the displays to the wall of their homes with commercially available mounts. Some of these mounts typically allow the display to be mounted very close to the wall. Due to the weight of the displays, and the desire to have the displays securely mounted to the wall, it is desirable to secure the mount into a wall stud rather than drywall. This mounting strategy faces a hurdle in instances where the wall has a veneer, such as a stone veneer attached to the wall. Such a veneer is usually unsuitable for securing a mount as it presents an uneven surface. Thus, it is desirous to secure a mount to the drywall surface behind the veneer. With the typical mount such a mounting would leave a large veneer free area on the wall to accommodate the mount. Further, with some mounts such as those that do not permit any adjustment or movement away from the wall, there would be insufficient room to mount the display on the mount because of the thickness of the veneer. Of course the veneer could be absent in an area behind the display, but such accommodation may not be correctly sized for a replacement display should the original need to be replaced.

Thus, it is desirous to have an interface or bracket to address the thickness of the veneer, and allow the mount to be placed as close as desired to the veneer. It is also desirous to have an interface or bracket that is relatively small and visually unobtrusive. It is also desirous to be able to place the veneer close to and around the bracket to visually hide the bracket. It is also desirous to have a bracket that allows easy placement and installation of the display or other article. It is also desirous to have a bracket that facilitates the mounting of articles other than a flat screen video display without the need to become intrusive to the existing support structure.

### SUMMARY OF THE INVENTION

The bracket assembly disclosed herein includes a wall bracket for attaching to a wall, and a display bracket for attaching an article such as a wall hanging, display, display mount, shelf, mantel, picture frame, or other desired article. The wall bracket includes a plate having a receiver, the receiver for receiving a post of the display bracket. The post may be a boss, tube, or other structure that may fit into the receiver. The receiver is generally angled in an upward direction, so that the post may be held in place in the receiver by gravity when the post is inserted into the receiver. The assembly may also include a device on one of the brackets to engage or secure the brackets together. The assembly may also include a fastener that is threaded into an aperture in the display bracket. The aperture is positioned below the post of the display bracket, allowing the fastener to be threaded into the threaded aperture from the display, front side, or non-opposing side of the display bracket plate and rest against or engage the outside surface of the receiver when the display bracket and the wall bracket are engaged, thus providing resistance against removal of the post from the receiver, thereby providing a more secure attachment of the assembly brackets to one another than gravity alone would provide.

The fastener also allows for adjustment of the distance between the wall plate and the display plate, thereby allowing for adjustment to fine tune the placement of the attached article, or to account for differing thickness of wall veneer. To adjust for the distance, the user positions the display bracket post into the wall bracket receiver and positions the bracket plates at the desired separation distance from one another, and then tightens the securing fastener to impinge on the receiver outer surface, thus securing the brackets of the assembly together and preventing the display bracket from moving away from or towards the wall bracket. In some embodiments, the outer surface of the receiver may include ridges, depressions, holes, or other structures to further aid in or increase the friction between the securing fastener with the receiver.

In some embodiments, the outer surface of the receiver may include a series of threaded holes or apertures positioned to align with the axis of the aperture for the securing fastener when the brackets are positioned at different spacings from one another. Such positioning of the receiver surface holes would allow the securing screw to be threaded into the receiver to provide a more secure attachment of the brackets to one another, and allow for preset spacing distances between the plates, and hence between the mount and the wall.

While a pair of mating brackets are shown, it is contemplated that any number of pairs of mating brackets may be used to secure an article to the wall. For instance, for most video display installations, the display mount is secured using two pairs of mating brackets.

### BRIEF DESCRIPTION OF THE DRAWINGS

FIG. 1 is a perspective view of the display bracket and wall bracket engaged as an assembly.

FIG. 2 is a perspective view of the display bracket and wall bracket in an unassembled relationship.

FIG. 3 is a perspective view of the display bracket.

FIG. 4 is a top view of the display bracket.

FIG. 5 is a display or back elevational view of the display bracket.

FIG. 6 is a left side view of the display bracket.

FIG. 7 is a front or post elevational view of the display bracket.

FIG. 8 is a right side view of the display bracket.

FIG. 9 is a bottom side view of the display bracket.

FIG. 10 is a perspective view of the wall bracket.

FIG. 11 is a top view of the wall bracket.

FIG. 12 is a front or receiver elevational view of the wall bracket.

FIG. 13 is a right side view of the wall bracket.

FIG. 14 is a back or wall view of the wall bracket.

FIG. 15 is a left side view of the wall bracket.

FIG. 16 is a bottom view of the wall bracket.

FIG. 17 is a cross-sectional side elevational view of the assembled brackets.

FIG. 18 is a top view of the assembled brackets.

FIG. 19 is a cross-sectional view of the assembled brackets looking towards the front of the display bracket.

FIG. 20 is a closeup of a portion of FIG. 17 showing the securing fastener contacting the surface of the receiver.

FIG. 21 is a perspective view of the bracket assembly positioned on vertical wall studs with a display mount attached, the display mount displaced from the wall plane formed by the wall studs.

### DETAILED DESCRIPTION OF THE PREFERRED EMBODIMENT

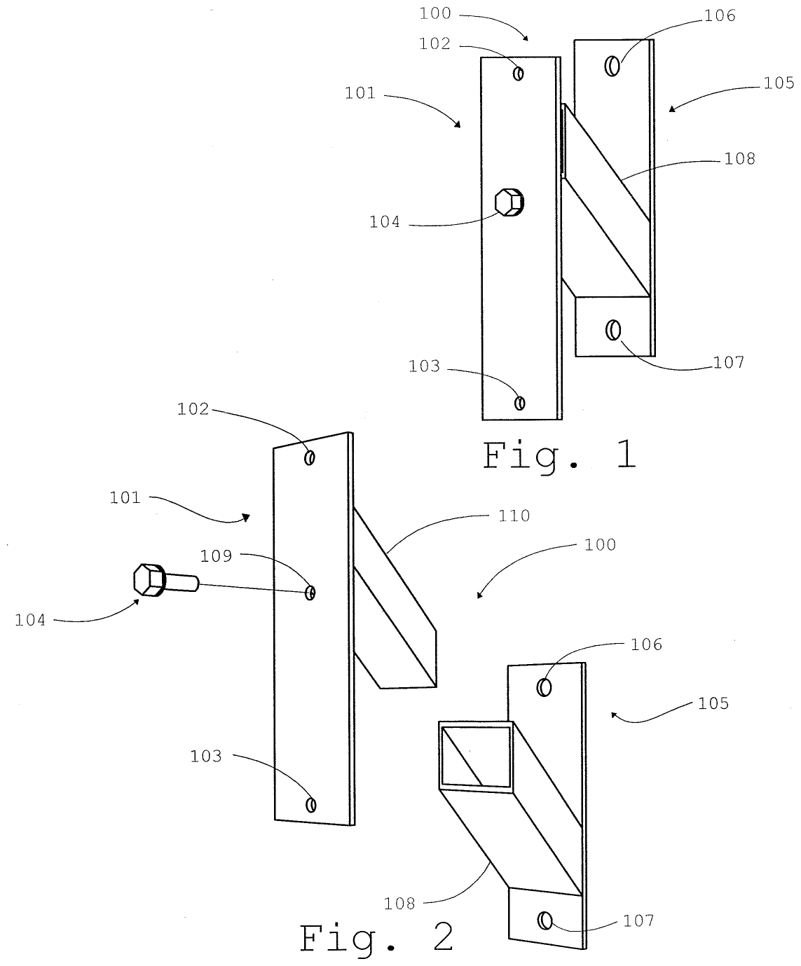

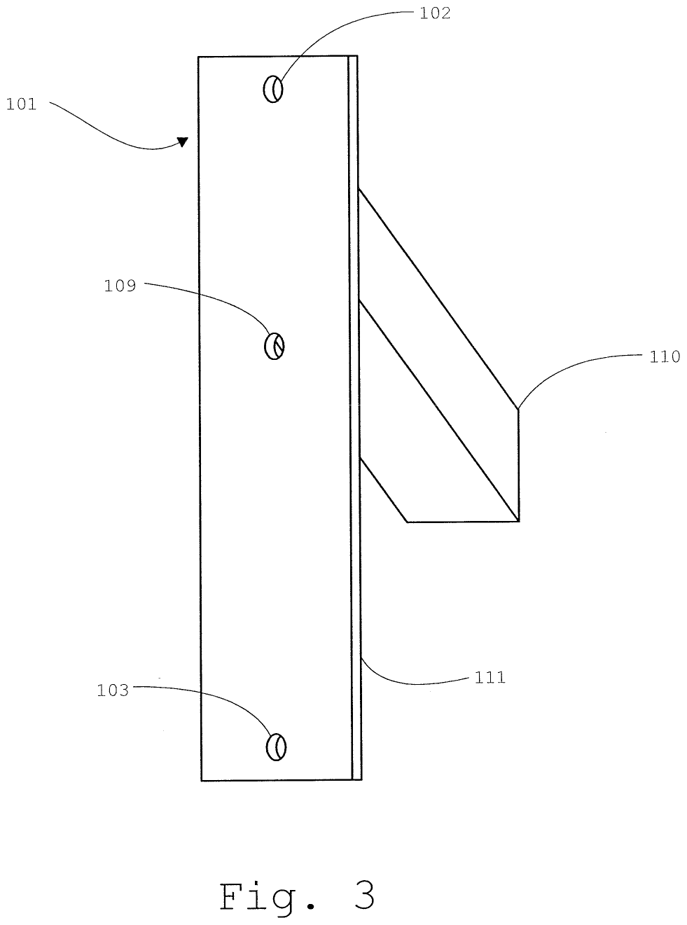

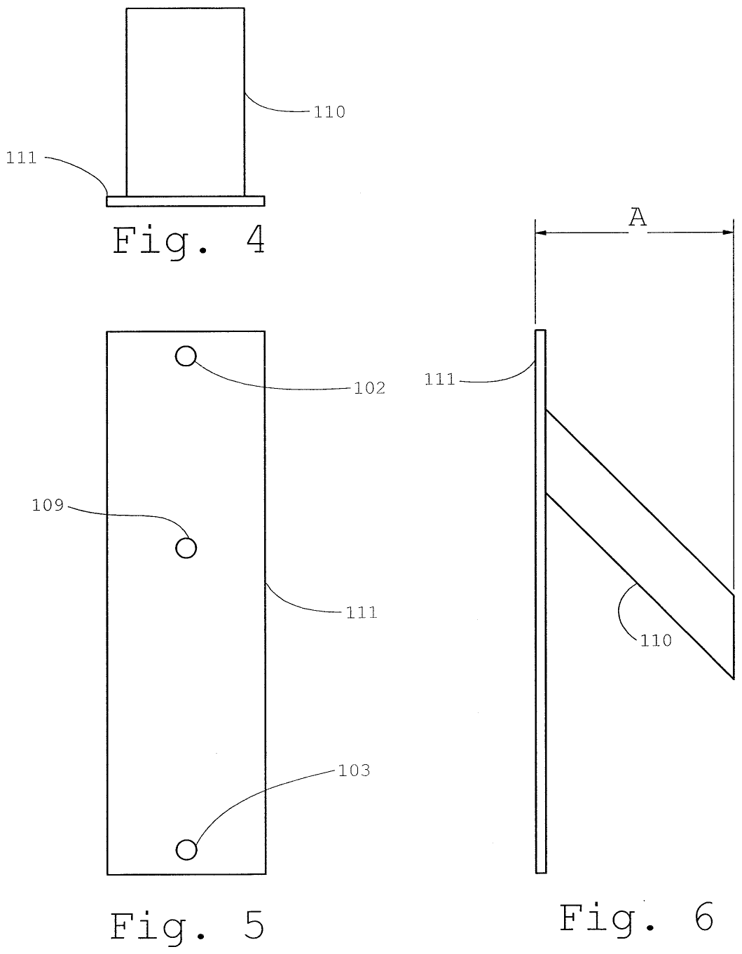

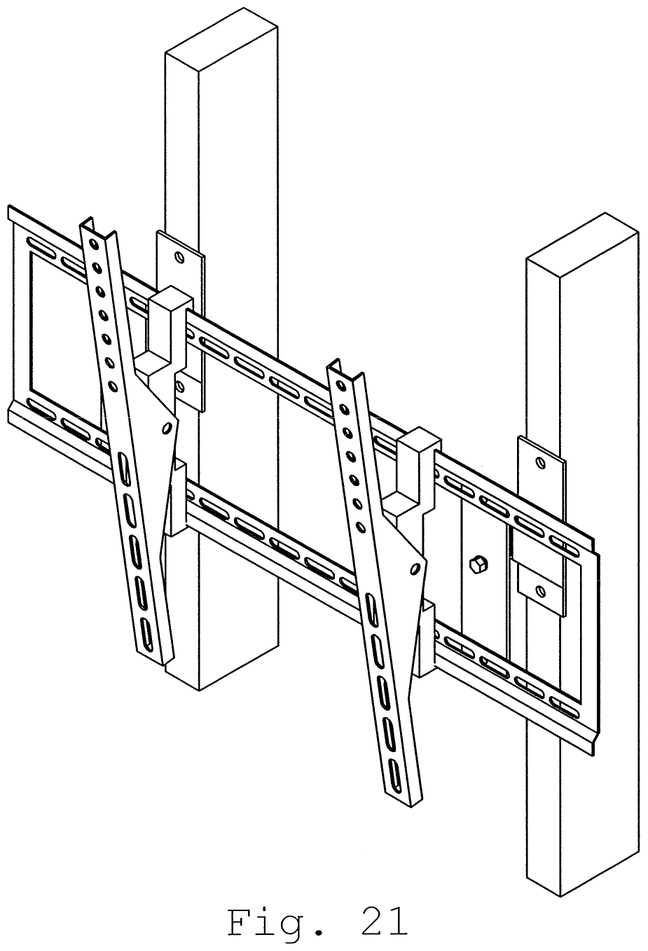

With reference to the figures, the assembly 100 includes a display bracket 101 and a wall bracket 105. The display bracket includes a post 110 or other structure that is inserted, mated, or in an engaging relationship with a receiver 108 of the wall bracket 105, as shown in FIGS. 1 and 17-21. One skilled in the art will recognize that the post 110 and the receiver 108 can be on either bracket. One skilled in the art will also recognize that the wall bracket 105 and the display bracket 101 have complementary structures that allow one to slidably engage with the other.

In the preferred embodiment, the receiver 108 is a length of square tube having an opening defined by walls, and the post 110 is a length of square tube of similar length, having walls of an exterior dimension that allow the post 110 to fit into the opening defined by the receiver walls. While square tube is shown in the drawings, one skilled in the art will recognize that other shapes can be used so long as the receiver 108 can receive the post 110. Further, the post 110 can be of any shape that will fit into the receiver 108 and need not have an exterior shape or number of walls that mimics the receiver. For instance, a round post 110 may be received by a triangular receiver 108. The post 110 may be solid or it may be hollow. The post 110 also need not be a tube, but may have a closed end. The post 110 also need not have the same cross section throughout its length. In some embodiments, the post 110 may be tapered to allow the end of the post 110 to be more easily inserted into the receiver 108.

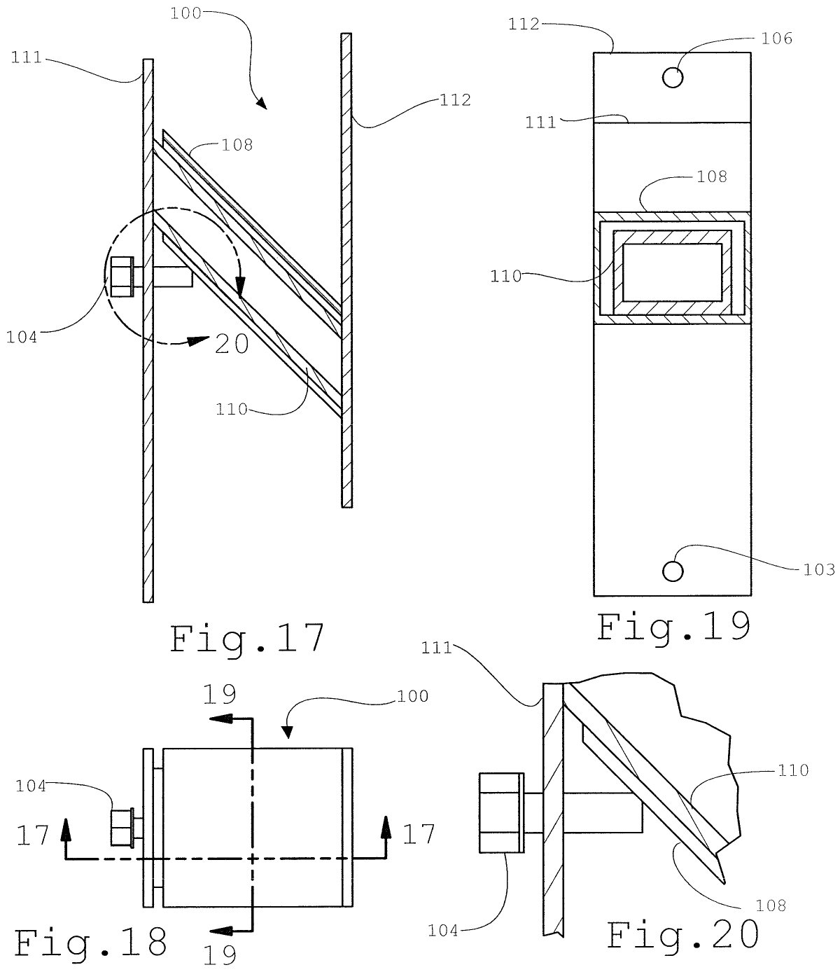

As shown in FIGS. 17 and 19, it is preferred that there is some room or play in the fit between the post 110 and the receiver 108. The fit of the post post 110 into the receiver 108 may have a variety of tolerances. However if the fit is too tight, it will be difficult to place the post into the receiver. It is most preferred that the post 110 and receiver 108 have a tolerance of fit of at least 1 mm. In some embodiments, the post 110 may be tapered so that the end is narrower that the base where the post 110 attaches to the plate 111. In other embodiments, the receiver opening may be wider at the open end than at the base where it attaches to the plate 112.

The wall bracket 105 and display bracket 101 can be similarly constructed. The display bracket 101 includes fastener aperture 109 in plate 111 for accepting a securing fastener 104. Fastener aperture 109 may be threaded to accept a threaded fastener. In the preferred embodiment, fastener 104 may be of sufficient length to contact the exterior surface of the receiver 108 when the brackets 101 and 105 are in a mated relationship.

The fastener aperture 109 is preferably located below the mounting locations of the post 110. Such positioning allows the securing fastener to contact the receiver 108 when the brackets are mated. In an alternate embodiment, the fastener aperture 109 is positioned so that the securing fastener 104 may contact any structure on the wall bracket 105.

The display bracket 101 includes a plate 111 or other structure to connect to an article such as a video display. The plate 111 may be generally flat and having perimeter edges, and may include an upper aperture 102 and a lower aperture 103 for accepting fasteners to attach an article or video display mount 200. The plate 111 includes a post 110 extending from a surface of the plate. The surface from which the post 110 extends generally faces or opposes the wall bracket 105 when the brackets are assembled.

The plate 111 and post 110 may be made out of any sturdy material, but are most preferably made of metal and welded together to form a bracket. The plate 111 may be rectangular in shape, having the major length in the up and down direction.

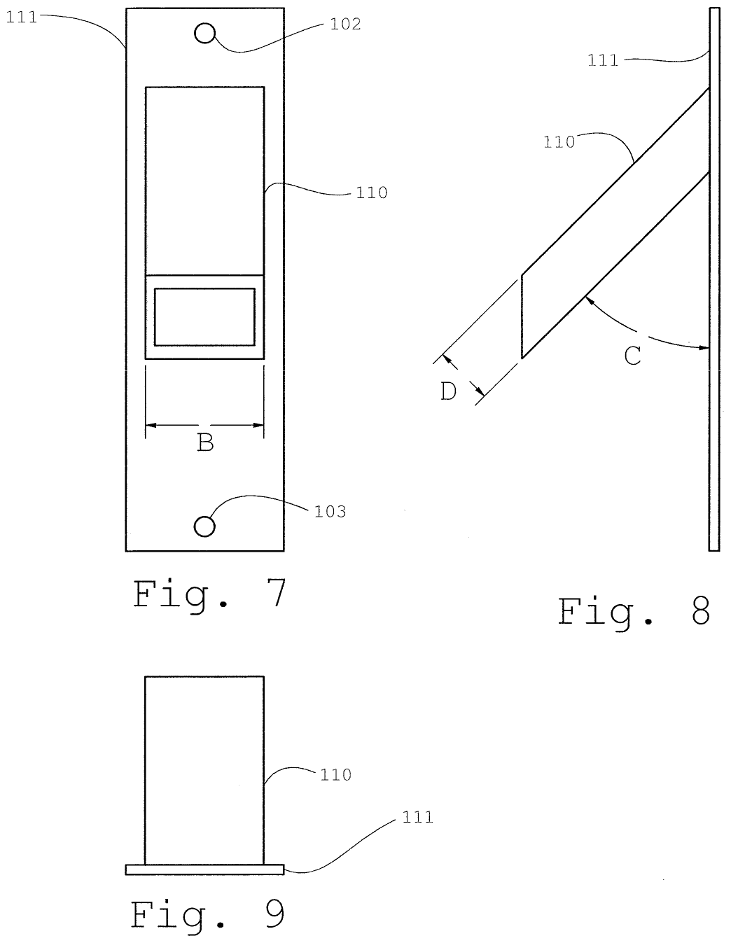

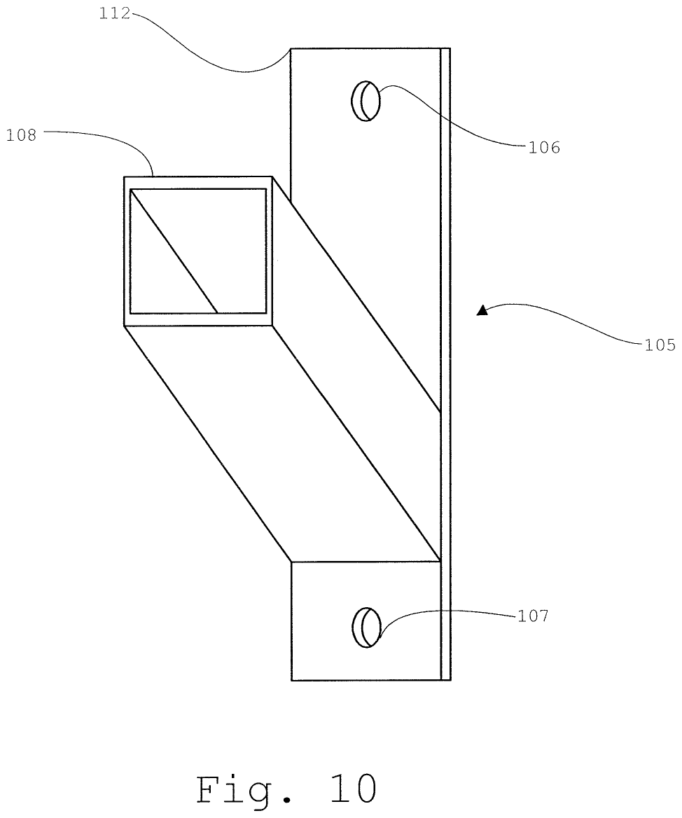

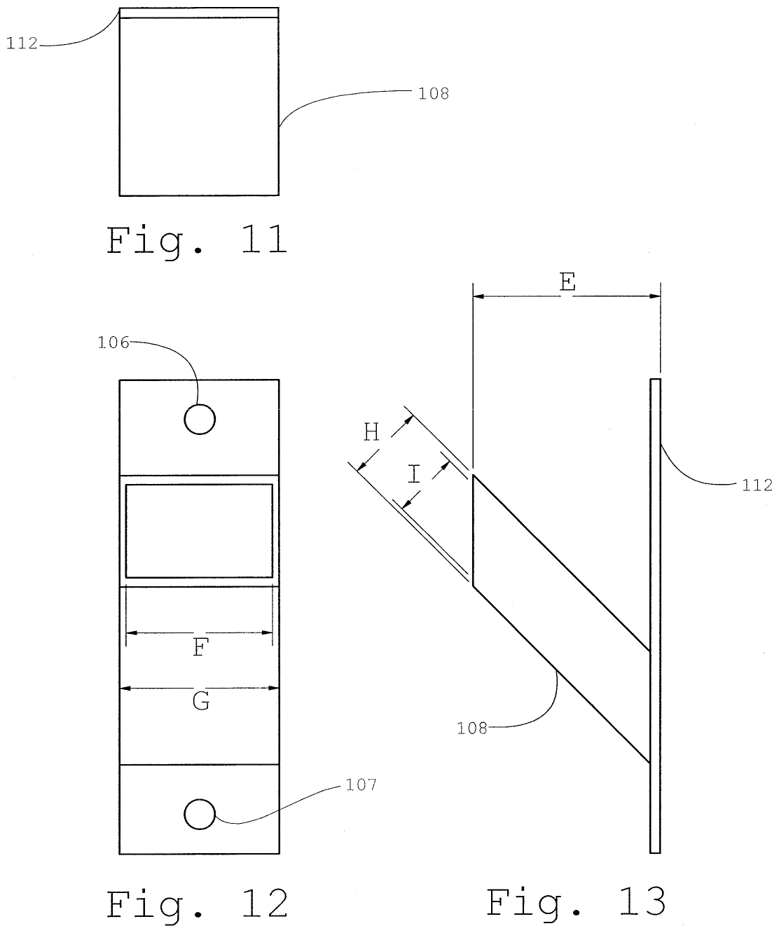

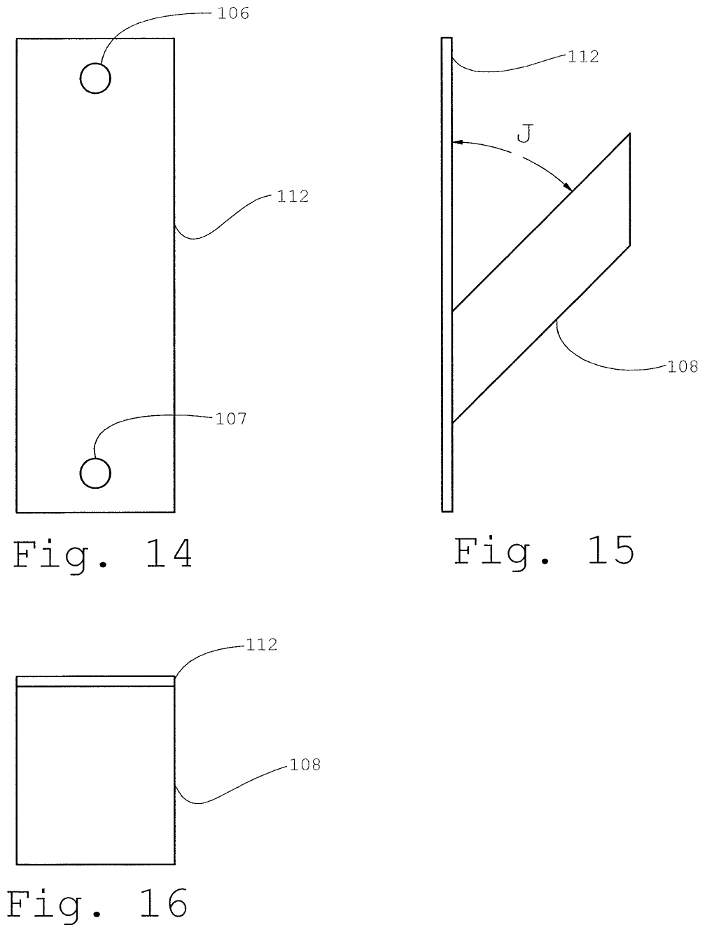

The post 110 is preferably mounted on the upper half of the plate 111 and extends at a downward angle. The post 110 is generally angled toward and over the middle portion of the plate 111. The angle formed between the post 110 and the plate 111, noted by C in FIG. 8, is preferably in the range of 90 to 30 degrees with 45 degrees being the most preferred, although other angels are possible. One skilled in the art will recognize that smaller angles allow for gravity to better secure the post 110 in the receiver 108, and allow for greater range of adjustment of the distance between the brackets to allow for different displacements of the article mounted to the wall.

The wall bracket 105 includes a plate 112 or other structure to connect to a wall or other vertical surface. The plate 112 may be generally flat and having perimeter edges, and may include an upper aperture 106 and a lower aperture 107 for accepting fasteners to attach the wall bracket 105 to a vertical surface such as a wall. The plate 112 includes a receiver 108 extending from a surface of the plate 112. The surface from which the receiver 108 extends generally faces or opposes the display bracket 101 when the brackets are assembled.

The plate 112 and receiver 108 may be made out of any sturdy material, but are most preferably made of metal and welded together to form a bracket. The plate 112 may be rectangular in shape, having the major length in the up and down direction. The receiver 108 is preferably mounted on the lower half of the plate 112 and extends at an upward angle. The angle of the receiver 108 and the post 110 are complementary so that the plate 111 and plate 112 are generally parallel to one another. The receiver 108 is generally angled toward and over the middle portion of the plate 112. The angle formed between the receiver 108 and the plate 112, is preferably in the range of 90 to 30 degrees with 45 degrees being the most preferred, although other angels are possible.

The foregoing disclosure of specific embodiments is intended to be illustrative of the broad concepts comprehended by the invention.

1. An assembly for attaching an article to a vertical surface, the assembly including a first bracket and a second bracket, the first bracket including a receiver extending from a first plate for securing the first bracket to the vertical surface, the second bracket including a post extending from a second plate, the post for insertion into the receiver.

2. The assembly of claim 1, where the assembly further includes a fastener, the fastener being positioned in an aperture in the second plate and in contact with the receiver.

3. The assembly of claim 1, wherein the aperture is threaded and the fastener is a threaded fastener.

4. The assembly of claim 1, wherein the receiver is a tube extending at an upward angle from the first plate when the first plate is positioned against a vertical surface, and the post extends from the second plate at a downward angle, allowing the first plate and second plate to be in a spaced apart parallel relationship when the post is in the receiver.

5. The assembly of claim 4, further including an aperture in the second plate, the aperture located below where the post attaches to the second plate.

6. The assembly of claim 5, further including a fastener for positioning in the aperture and against the receiver to prevent the post from being removed from the receiver.

7. A gravity bracket assembly for mounting articles to a vertical surface, the assembly including:
a first bracket having a first plate for mounting on the vertical surface, the first bracket including a receiver extending upward and away from the first plate;
a second bracket having a second plate for mounting an article, the second bracket including a post extending downward and away from the second plate, the first and second plate being parallel when the post is positioned in the receiver.

8. The assembly of claim 7, further including a fastener positioned in an aperture located on the second plate below where the post attaches to the second plate, the fastener also in contact with the receiver when the post is positioned in the receiver.

9. The assembly of claim 8, whereby the fastener selectively secures the post and receiver to allow for the second plate to be positioned at selected distances from the first plate.
